(19) United States
(12) Patent Application Publication
(10) Pub. No.: US 2008/0264422 A1
(43) Pub. Date: Oct. 30, 2008

(54) Sleep apnea CPAP headgear

(76) Inventor: Graham A. Fishman, West Bloomfield, MI (US)

Correspondence Address: HARNESS, DICKEY & PIERCE, P.L.C., P.O. BOX 828, BLOOMFIELD HILLS, MI, 48303, US

(21) Appl. No.: 12/074,596

(22) Filed: Mar. 5, 2008

Related U.S. Application Data
(60) Provisional application No. 60/897,295, filed on Apr. 30, 2007.
(60) Provisional application No. 60/899,357, filed on Apr. 27, 2007.
(60) Provisional application No. 60/897,294, filed on Apr. 27, 2007.

(51) Int. Cl. A62B 18/08

(52) U.S. Cl. 128/207.11

(57) ABSTRACT

A sleep apnea CPAP mask headgear system is provided which utilizes a vertical adjustable band along with a single lower horizontal adjustable band. The single horizontal strap is coupled to the sleep apnea CPAP mask using quick coupling fasteners. Spring biasing is applied to bias the mask to a user's face.

### CROSS-REFERENCE TO RELATED APPLICATIONS

This application claims the benefit of U.S. Provisional Application No. 60/897,295, filed on Apr. 30, 2007; and U.S. Provisional Application No. 60/899,357, filed on Apr. 27, 2007; and U.S. Provisional Application No. 60/897,294, filed on Apr. 27, 2007. The disclosures of the above applications are incorporated herein by reference.

### FIELD

The present disclosure relates to headgear for sleep apnea and more particularly to a headgear system for a CPAP mask for sleep apnea which increases the likelihood of CPAP system use.

### DISCUSSION OF THE RELATED ART

Many people diagnosed with sleep apnea refrain from using the CPAP (Continuous Positive Airway Pressure) equipment on a regular basis. Reasons include the noise from the CPAP machine or the contact of the mask and associated headgear itself upon the nasal area. Although there are many causes for the low equipment usage rate, often user's stop using the equipment because of the discomfort caused by the system's mask restraint mechanism. These restraint mechanisms typically have a two horizontal band restraint system which many users find claustrophobic.

### SUMMARY

It is an object of the present teachings to provide a system which alleviates the claustrophobia effects which could be associated with existing two horizontal band sleep apnea headgear. To this end, the teachings herein introduce a derivation of a traditional headgear available for a CPAP sleep apnea mask. In one embodiment, this modified headgear integrates the traditional mask to a rigid, lightweight plastic contoured headband with a spring loaded connection to press the sleep mask snugly to the user's face. The spring loaded attached mask is configured to stay secure to the user's face to ensure that proper CPAP pressure is maintained.

The spring loaded mask minimizes the contact of banding upon the wearer's face and reduces the unsightly marks left behind after the user wears the mask. The uniqueness of these teachings lies in the spring loaded attachment of the headband to the mask and its performance to press against the user's nasal area to secure reception of proper air pressure from the CPAP device. A proper seal reinforces the effect of the CPAP process and minimizes forced air leaks which could also dry the wearer's eyes.

In another embodiment, the teachings introduce a modified headgear for the sleep apnea CPAP mask that couples a traditional sleep apnea mask to a rigid, lightweight plastic contoured headband and adjustable strap via a spring loaded connection positioned above the bridge of the user's nose. The spring ensures adequate force on the sleep mask to snugly couple the mask to the user's face. The spring loaded attached mask is configured to stay secure to the user's face to ensure proper CPAP pressure is maintained.

This spring loaded mask is configured to 1) alleviate the claustrophobia which could be associated with existing sleep apnea headgear that have two horizontal bands surrounding the mask wearer's head, 2) minimize the contact of strapping upon the wearer's face which may leave unsightly marks left behind after the user wears the mask, 3) reduce the accidental leakage of air from the edges of the mask which can dry the user's eyes, and 4) provide a simple adaptation via less user adjustment.

In another embodiment, a sleep apnea CPAP mask headgear system is provided which utilizes a vertical adjustable band along with a single lower horizontal adjustable band to alleviate claustrophobia and minimize the facial marks which can result after wearing traditional sleep apnea headgear.

In yet another embodiment, a sleep apnea CPAP mask headgear system is provided which utilizes a vertical adjustable band along with a single lower horizontal adjustable band. The single adjustable horizontal strap is coupled to the sleep apnea CPAP mask using quick coupling/decoupling fasteners.

Further areas of applicability of the present teachings will become apparent from the detailed description provided hereinafter. It should be understood that the detailed description and specific examples, while indicating the preferred embodiment of the teachings, are intended for purposes of illustration only and are not intended to limit the scope of the teachings.

### BRIEF DESCRIPTION OF THE DRAWINGS

The present teachings will become more fully understood from the detailed description and the accompanying drawings, wherein:

FIG. 1 is a perspective view of the teachings of the two point sleep apnea CPAP mask headgear;

FIG. 2 is a frontal view of the teachings of the two point sleep apnea CPAP mask headgear shown in FIG. 1;

FIG. 3 is a side lateral view of the teachings of the two point sleep apnea CPAP mask headgear shown in FIG. 1;

FIG. 4 is a back side view of the teachings of the two point sleep apnea CPAP mask headgear shown in FIG. 1;

FIG. 5 is a top view of the teachings of the two point sleep apnea CPAP mask headgear shown in FIG. 1;

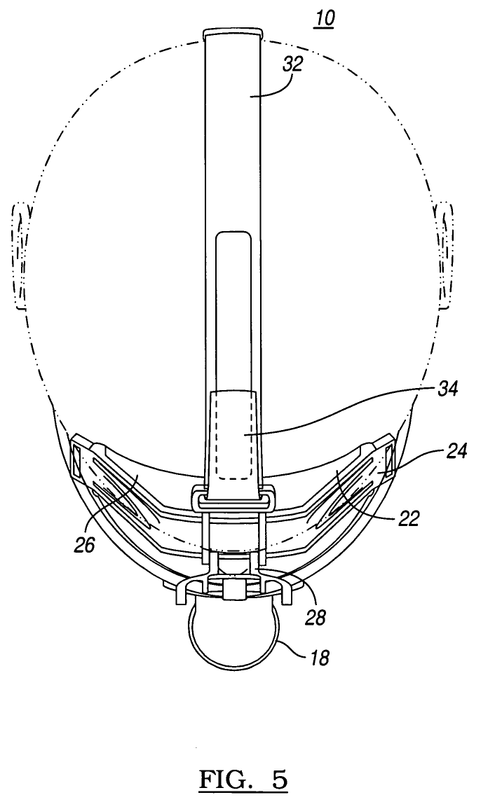

FIG. 6 is a perspective view of the teachings of an alternate three point sleep apnea CPAP mask headgear;

FIG. 7 is a frontal view of the teachings for the three point sleep apnea CPAP mask headgear shown in FIG. 6;

FIG. 8 is a side view of the teachings of the three point sleep apnea CPAP mask headgear shown in FIG. 6;

FIG. 9 is a back side view of the teachings of the three point sleep apnea CPAP mask headgear shown in FIG. 6;

FIG. 10 is a top view of the teachings of the three point sleep apnea CPAP mask headgear shown in FIG. 6;

FIG. 11 is a perspective view of the teachings of the hinged sleep apnea CPAP mask headgear;

FIG. 12 is a frontal view of the teachings of the hinged sleep apnea CPAP mask headgear shown in FIG. 11;

FIG. 13 is a side lateral view of the teachings of the hinged sleep apnea CPAP mask headgear shown in FIG. 11;

FIG. 14 is a rear side view of the teachings of the hinged sleep apnea CPAP mask headgear shown in FIG. 11; and

FIG. 15 is a top view of the teachings of the hinged sleep apnea CPAP mask headgear shown in FIG. 11.

### DETAILED DESCRIPTION OF THE PREFERRED EMBODIMENTS

The following description of the preferred embodiments concerning an apparatus and method for retaining a sleep apnea mask on a patient is merely exemplary in nature and is in no way intended to limit the teachings, its application, or uses.

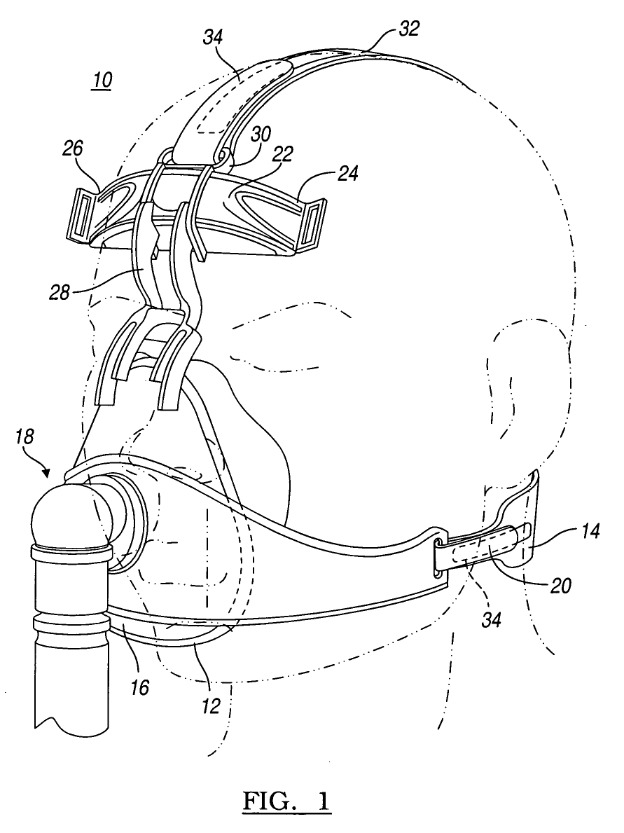

FIG. 1 shows a frontal view of the system 10 adapted to a sleep apnea mask 16. In this regard, the system 10 is configured to position a Respironics™ sleep apnea mask on the face of a patient. The prescription for the typical CPAP machine (not shown) coupled to the mask 16 may typically provide from zero (0) to twenty (20) CFM's (cubic feet per minute) positive pressure. The system 10 according to the present teaching is configured to maintain a minimum counterforce against the patient's face to ensure the CPAP pressure does not overtake and break the air-seal 12 application of the mask to the user's face. A horizontal band 14 is fixed on one side to the mask 16 which is positioned over the swivel airway intake spout 18. It is adjusted on the side of the face with a Velcro™ adjustment band 20 which loops through the opposing side of the swivel airway intake spout restraint.

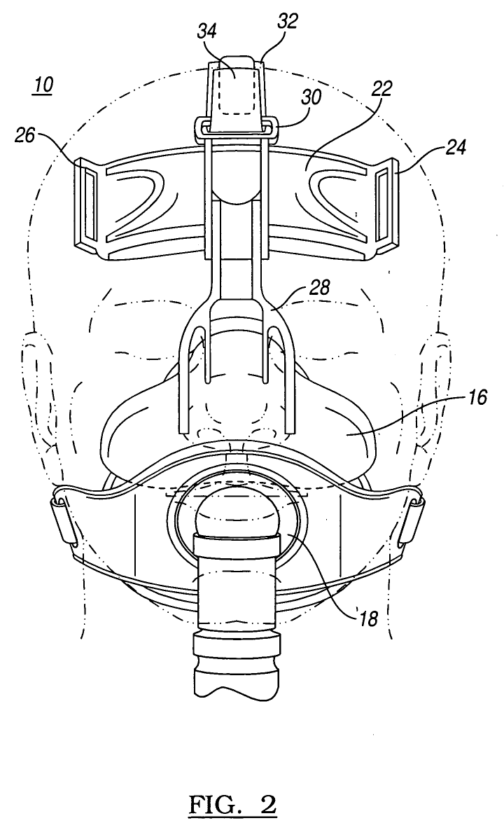

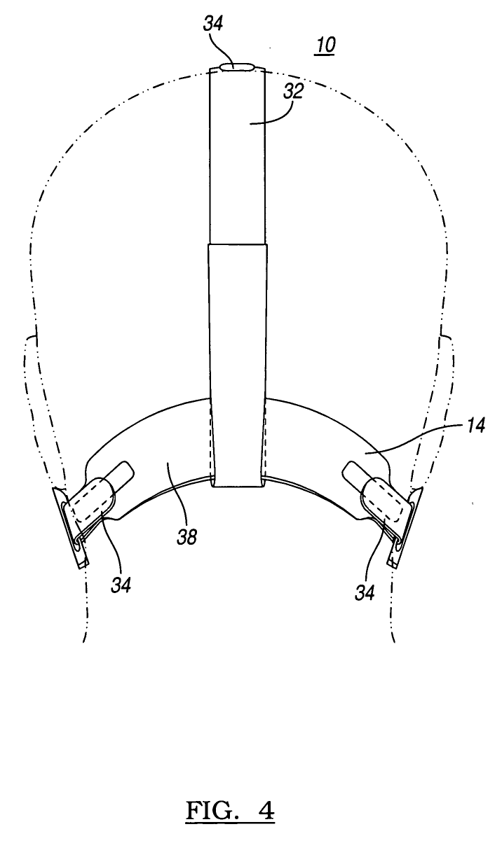

FIG. 2 provides a front view which shows a forehead positioning pad 22. The positioning pad 22 is formed of a pair of stabilizing flanges 24, 26 which project generally perpendicular to a coupling portion 28 that couples the positioning pad 22 to the mask 16. The positioning pad 22 has an integrated strap retention mechanism 30. One end of a top vertical band 32 feeds through the integrated strap retention mechanism 30. The vertical band adjustment 34 in FIG. 2 aids in securing the positioning pad 22 snugly to the wearer's forehead to prevent air leaks from the mask 16. The other side of this vertical band is anchored to the junction of the horizontal bands 38 situated in the back of the head (see FIG. 4). The junction of the horizontal bands 38 is an anchor which is movable, and permits the horizontal band to glide through it, thus permitting compatibility with various size patients' heads. The horizontal band adjustments 34 are seen on both sides of the face with Velcro™ bands chosen to loop on either side of the mask (similar to the overhead Velcro™ loop (shown in FIG. 1) and are positioned below the wearer's ears. It is important the horizontal band is kept below the ears to ensure counter pressure for the mask seal 12 against the upper vertical band 32. The integrity of the mask seal 12 would be compromised by the strap riding up over the ears.

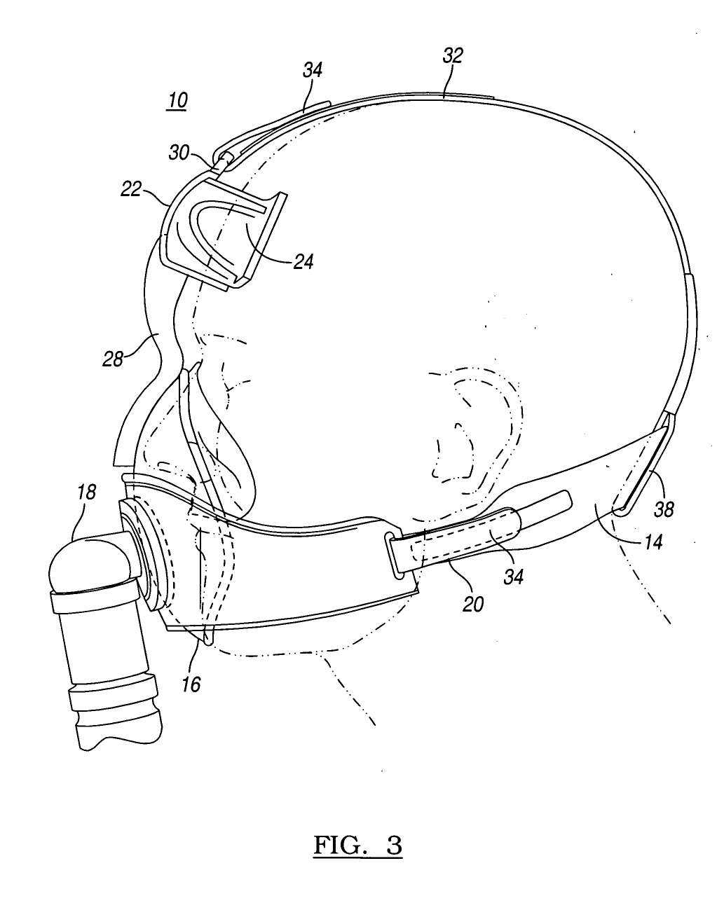

FIG. 3 shows the system 10 from a side view. The top vertical band 32 attaches through the loop 30 from the forehead positioning pad 22 and to the rear of the horizontal band 38. While the vertical strap is shown disposed through the loop 30, it is envisioned the vertical strap can utilize a quick couple fastener or buckle to de-couple the vertical strap from the mask. This side view also exemplifies the intent of the design to centrally apply pressure to the mask 16 over the user's nasal area. It is critical to have the mask seal 12 securely to the wearer's face to prevent the outflow of the pressurized ambient air which would negate the effect of the CPAP process and could also dry the wearer's eyes with the air flow. FIG. 4 shows the teachings from a rear head form view. This view shows the horizontal band/vertical band intersection 38 to permit adjustment to fit all head forms since the horizontal band 20 can change length depending on the user's head size.

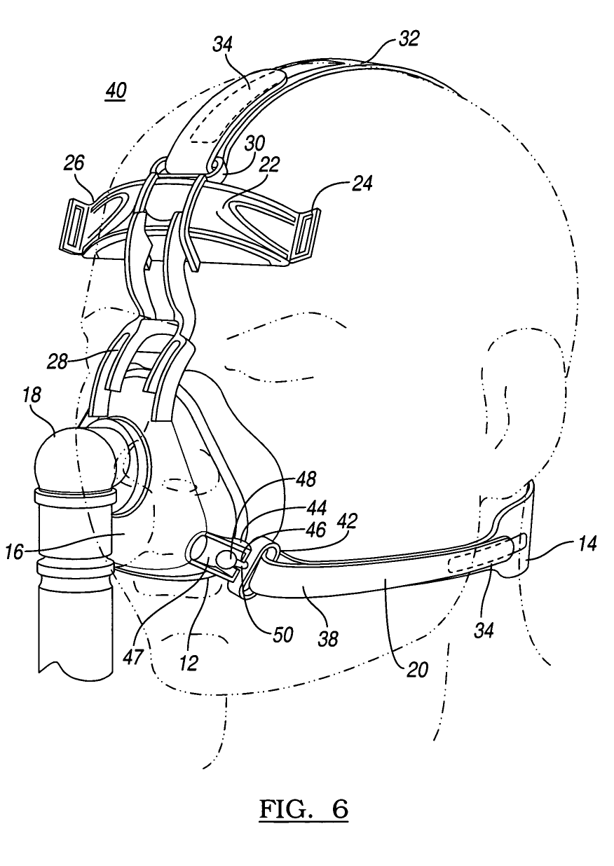

FIGS. 6 through 10 show an alternate system 40 adapted to a sleep apnea mask 16. The system 40 is similar to the system 10 described above. The horizontal bands 20 attached to the mask 16 via removable plastic snap-in connectors 42. The snap-in connectors 42 connect the horizontal band 20 to the lower left and right facial mask receptacles 44. The mask receptacles 44 define a slot 46 and a ball accepting aperture 47.

The snap-in connector 42 has a coupling ball 48 coupled to a strap engaging loop via a flange member 50. After adjusting the length of the horizontal strap 20, a patient positions the ball 48 in the ball accepting aperture 47 while placing the flange member into the slot 46. This releasably couples the horizontal strap 20 to the mask 16 in a manner which can be quickly engaged or released.

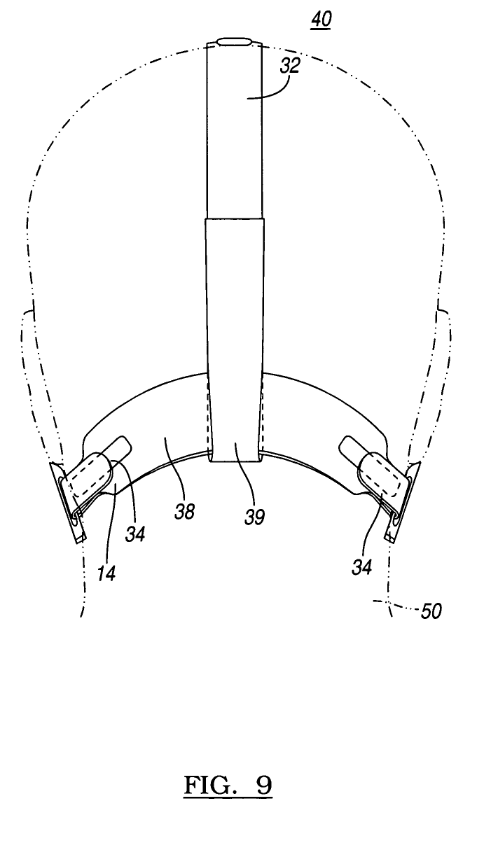

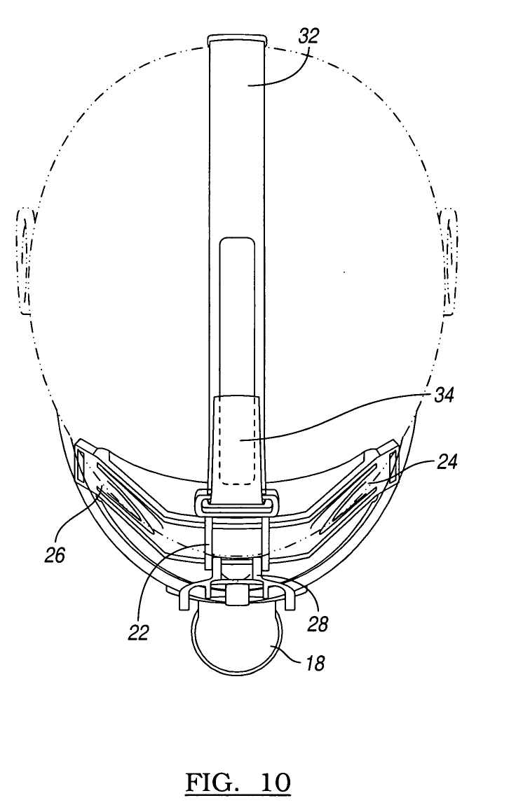

As described above, the top vertical band 32 attaches onto one end of the top of the forehead positioning pad 22 and also to the rear section of the horizontal bands 38 (See FIGS. 9 and 10). The horizontal bands 20 can be adjusted on both sides of the face with Velcro™ material on these bands which loop on either side of the mask (similar to the overhead Velcro™ loop shown in FIG. 6). One end of the top vertical band 32 is fed through the fixed plastic loop or mechanism 30 integrated into the forehead positioning pad 22. This part of the vertical band 32 would then be adjusted by the sleep apnea mask user to secure the forehead attachment 22 snugly to the wearer's forehead to prevent air leaks from the mask 16. The top forehead pad serves to ensure the mask seals 12 adequately against the bridge of the user's nose to ensure efficient air transfer into the user's nasal passage.

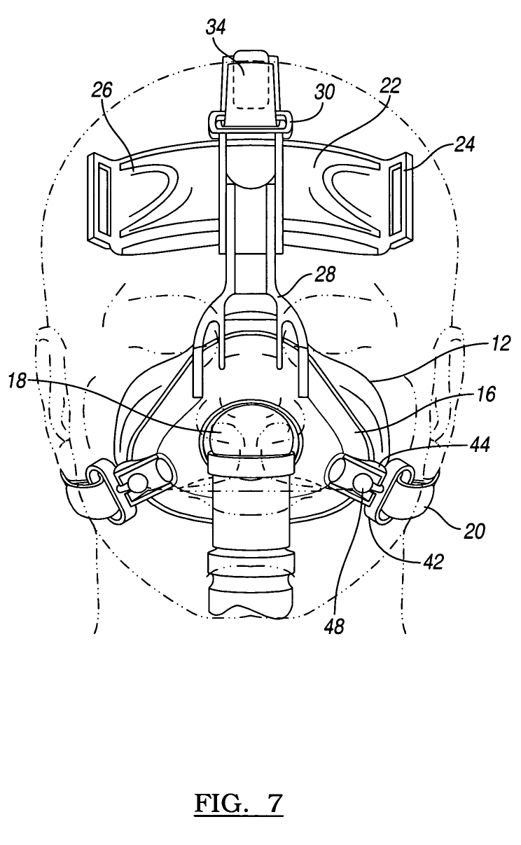

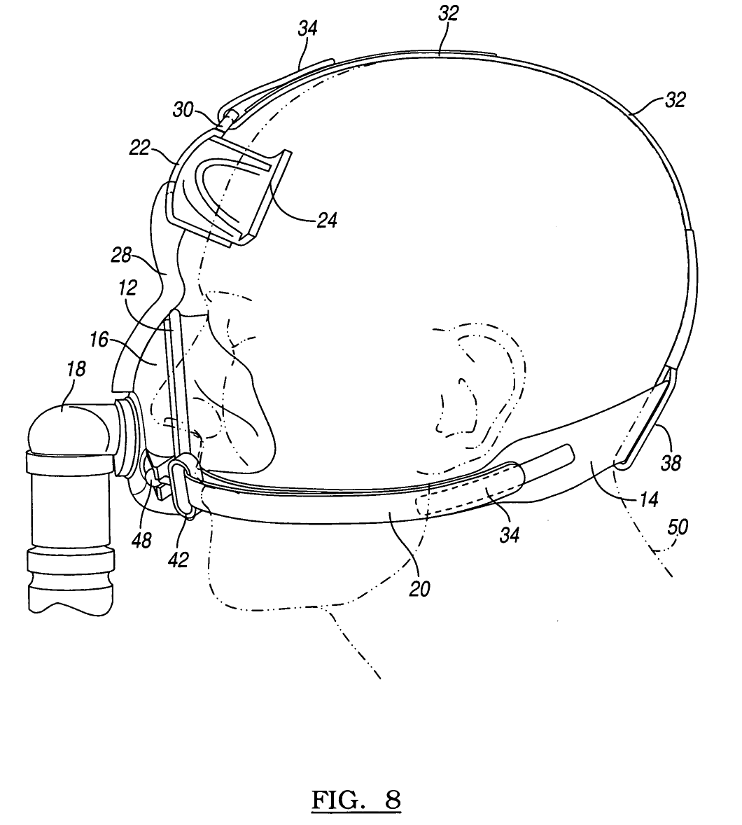

The three user adjustments are the elastic bands which a) attach to the top of the forehead positioning pad 22; b) the left; and c) right sides of the horizontal headband attachments which snap into the lower portion of the frontal mask 16 (see FIGS. 7 and 8).

The top forehead pad 22 also serves to ensure the mask seals adequately against the bridge of the user's nose to ensure efficient air transfer into the user's nasal passage. As the prescription for the typical CPAP machine may provide from zero (0) to twenty (20) CFM's (cubic feet per minute) positive pressure. Therefore, the three attachments are configured to ensure maintaining a minimum force against the user's face to ensure the CPAP pressure does not overtake and break the air-seal application of the mask to the user's face. With most traditional CPAP mask attachment mechanisms, the horizontal band of the upper mask restraint circumnavigates and is positioned upon the frontal, temporal, parietal and occipital regions of the human head. The bands of the restraint system may also extend over a portion of the orbital bone region with a minimum of contact due to the standoff created by the formed headpiece/strap attachment (FIG. 8) which abuts the forehead between the eyes. The lower bands of the mask headgear restraint traverse portions of the mandibular section of the lower face along with the masseter and buccinator muscle groups. While the pressure exerted by the horizontal bands (20) is not severe enough to constrict blood flow through the lower face, the banding may leave some temporary marks upon the skin from the irritation caused when the band contacts this tissue. It may also cause discomfort as a result of the pressure the bands place upon the nerves within the cutaneous tissues in this area.

FIGS. 7 and 8 provide front and side views of the modified forehead positioning pad 22 with integrated strap retention mechanism. This view shows one end of the top vertical band feeding through the forehead positioning pad plastic loop 30. The vertical band adjustment 34 in FIG. 7 aids in securing the forehead attachment snugly to the wearer's forehead to prevent air leaks from the CPAP machine. The other side of this vertical band is anchored to the junction of the horizontal bands situated in the back of the head (see FIG. 10). The horizontal band adjustments 34 are seen on both sides of the face with Velcro™ bands chosen to loop on either side of the mask (similar to the overhead Velcro™ loop (shown in FIG. 6) and are positioned below the wearer's ears. It is important the horizontal bands 20 are kept below the ears to ensure counter pressure for the mask seal against the upper vertical band. The integrity of the mask seal 12 would be compromised by the straps riding up over the ears.

FIG. 10 shows the teachings from a top view. The top vertical band attaches through the loop from the forehead positioning pad 22 and to the rear of the horizontal band (see FIG. 9). This top view also exemplifies the intent of the design to centrally apply pressure to the mask application over the user's nasal area. It is critical to have the mask seal securely to the wearer's face to prevent the outflow of the pressurized CPAP machine air which would negate the effect of the CPAP process and could also dry the wearer's eyes with the air flow.

FIGS. 9 and 10 show the system 40 from a rear head form view. These views show the horizontal band 38 fitted within the vertical band 32 to permit adjustment to fit all head forms since the horizontal band 38 can change length depending on the user's head size. This vertical strap 32 continues forward over the top of the head to the forehead positioning pad loop 30 (FIGS. 6 and 7). The system 40 can ensure centering application of the front mask 16 by assuring the band intersection 39 stays securely in the mid section on the back side of the head and does not interact with the neck.

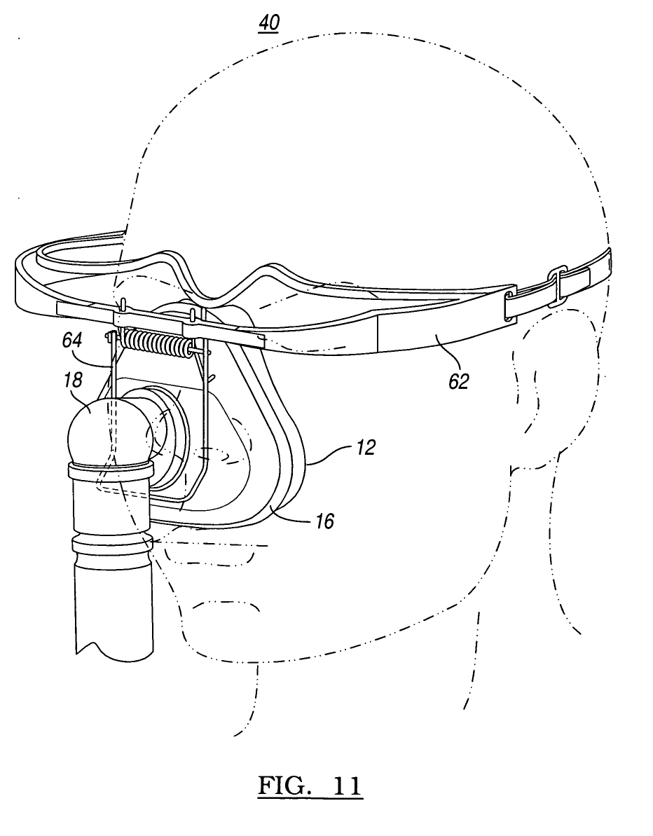

FIG. 11 represents a perspective view of an alternate system 60 adapted to a sleep apnea mask 16. The system 60 has a contoured horizontal adjustable headband 62 using a spring loaded mechanism 64 to the mask 16. In this regard, the mask 16 is rotatably hinged to the headband 62. Disposed between the mask 16 and the headband 62 is the spring mechanism 64 which biases the mask 16 into in the patient's face.

The system 60 is configured to alleviate short term facial marring since prior art attach systems can and do contact the frontal, temporal, parietal, occipital and orbital regional muscles with their horizontal positioning about the human head. The horizontal band 62 of this mask restraint circumnavigates and contacts the temporal, parietal and occipital bone area of the human head and through spring force will secure the CPAP mask 16 to the user's nasal area and provide for a minimum of air leakage, thus ensuring the user receives the proper dosage of intake air to keep their airway open. Again, the pressure exerted by the contact of this upper band will not be severe enough to constrict blood flow through the temporal, parietal and occipital regions and their associated muscles and nerves. It will also alleviate the high incidence of short-term marks or bruising from tight contact formed against the muscles. It is the physical constriction and emotional/psychological feelings or containment by present headgear strapping which this new teaching is intended to mitigate.

The single, adjustable elastic band 62 is generally positioned against the muscular group situated over the temporal, parietal and occipital regions of the human head. There should be approximately a 0.5 newton-meter preload from the spring to initially position the mask 90 degrees from the contoured headband and an additional 3.0 to 5.5 newton-meters of loaded force applied by the hinged spring 64 to the mask 16 for the user's face. In this regard, the spring force for a petite mask, a force of about 3.0 n/m may be appropriate. A force of about 4.0 n/m for a small mask; a force of about 4.4 n/m for a medium mask; and a force of about 5.2 n/m for a large mask. It is envisioned that a mechanism can be associated with the spring which will enable adjustment of the spring force applied to the mask. This mechanism can be, for example, a dial or gear which biases the spring ends or the movement arm of the force.

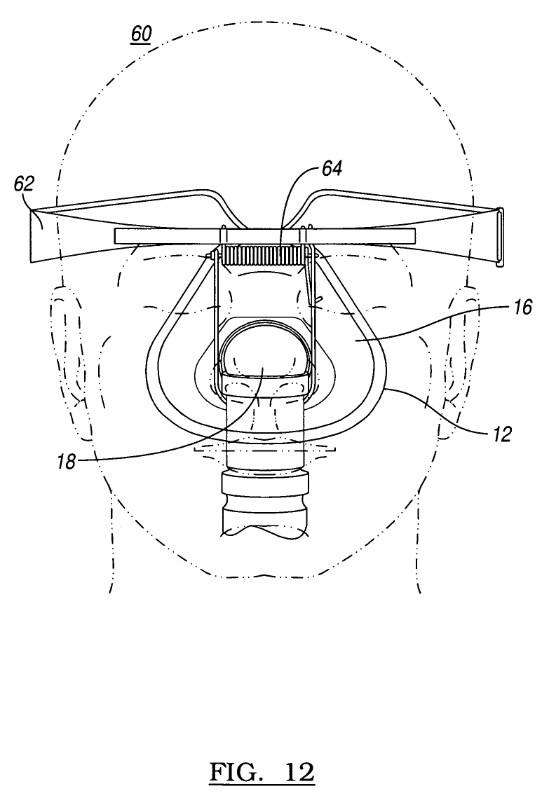

FIG. 12 shows a front view of a sleep apnea mask 16 with the spring loaded bar 64 pressing against the mask 16. The pressure will be applied evenly on the bottom, left, and right sides of the air intake swivel component 18 by integrating a properly loaded horizontal spring 64 into the contoured horizontal headband 62. This spring 64 is designed to provide an adequate amount of loading to the user's face without providing an unpleasant amount of force in order to ensure uniform pressure applied upon the central portion of the mask 16 and transferring outward to the perimeter of the flexible seal 12 which joins at the wearer's face. Optionally, the spring mechanism would include embedded spring or tension bars into the mask 16 or the headband 62. This could be done by utilizing existing snap-in features or molded slots. This is necessary to prevent the user from being pinched or scraped by the mechanically loaded tension components of the spring 64.

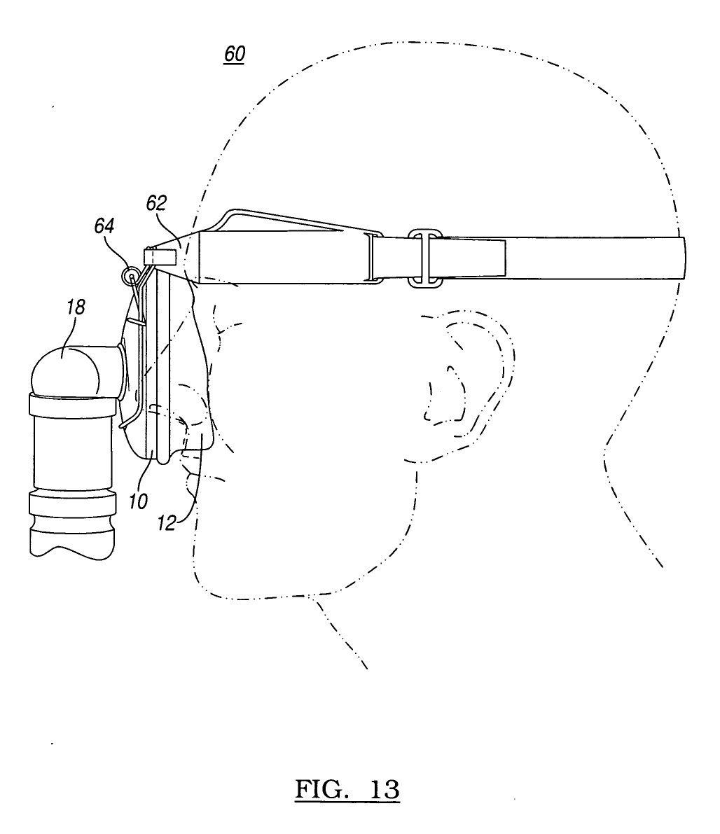

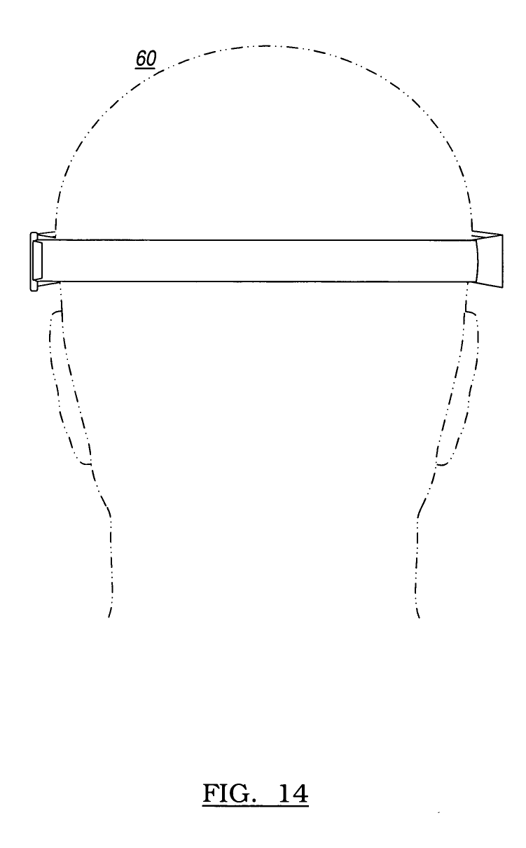

FIG. 14 shows a rear head form view of the system depicted in FIG. 11. The headband 62 is simplified with only one horizontal band. The horizontal elastic band, which attaches to the marked-up contoured horizontal headband, is fixed on the right side and can be adjusted on the left side. It is envisioned the headgear can be produced for left or right-handed people; a fixed band on the left side would have the adjustment on the right side for right-handed people; the unit shown in FIG. 13 has the band fixed on the right side with adjustment on the left-side for left-handed people.

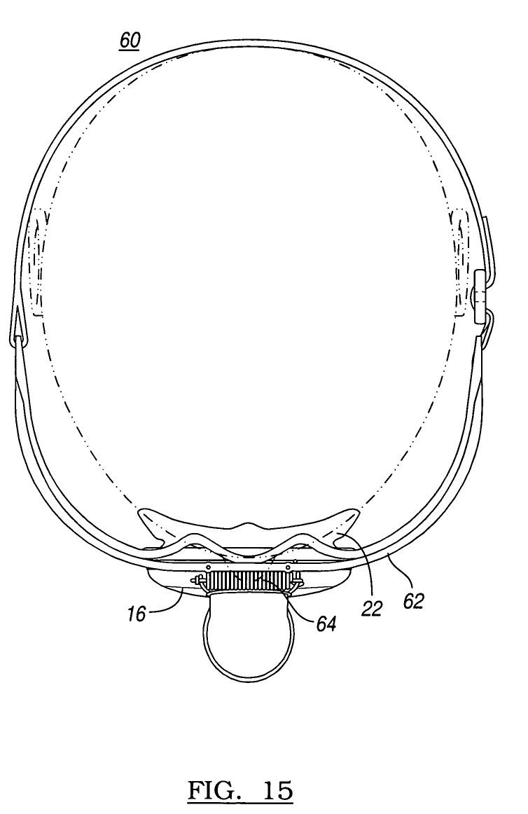

FIG. 15 shows a top view of the system of FIG. 11. The contoured horizontal headband 62 has a forehead engaging pad 22 which fits snugly against the user's forehead to permit proper positioning of the mask 16 to the user's face in the nasal area. The contoured horizontal headband 62 has a wraparound feature to permit the mask wearer the comfort of having the adjustable attachment band stay flush to their head (see FIG. 14). This top view also exemplifies teachings herein to centrally apply pressure to the mask 16 over the user's nasal area while not irritating the spheroid and orbital regions. It is mandatory for the mask 16 to seal securely to the wearer's face to prevent the outflow of the pressurized ambient air produced by the CPAP unit. The spring loaded mask seen from this angle provides a view showing how flush the mask could be seated by the tensioned bars on the front of the mask.

The description of the teachings is merely exemplary embodiments in the present teachings. One skilled in the art would readily recognize from such discussion and from accompanying drawings and claims that various changes, modifications, variations may be made therein without the spirit and scope of the teachings.

What is claimed is:

1. A sleep apnea headgear system comprising:
a sleep apnea CPAP mask;
a contoured headband; and
a spring loaded mechanism disposed between the headband and the mask, wherein the spring loaded mechanism is configured to press the sleep mask snugly to a user's face.

2. The system according to claim 1 further comprising a single fabric band coupled to the contoured headband.

3. The system according to claim 1 wherein the contoured headband is rotatably coupled to the mask.

4. The system according to claim 1 wherein the spring loaded mechanism comprises a coil spring.

5. The system according to claim 1 wherein the spring loaded mechanism applies approximately a 0.5 newton-meter preload from the spring to initially position the mask 90 degrees from the contoured headband and an additional 4.5 newton-meters of loaded force against a patient's face.

6. The system according to claim 1 further comprising an air source which provides from greater than zero to twenty cubic feet per minute positive pressure to the mask.

7. The system according to claim 1 wherein the mask comprises a swivel air intake spout.

8. A sleep apnea headgear system comprising:
a sleep apnea CPAP mask;
a positioning pad;
a spring disposed between the mask and the positioning pad; and
a central strap coupled to the positioning pad, said central strap configured to pass over a crown of the head; and
a second strap coupled to the mask, said strap configured to surround the head below a user's ears and coupled to the central strap.

9. The system according to claim 8 wherein the positioning pad comprises a pair of stabilizing flanges.

10. The system according to claim 8 further comprising a coupling portion between the mask and the positioning pad.

11. The system according to claim 8 wherein central strap comprises a length adjustment mechanism.

12. The system according to claim 8 wherein the mask applies approximately a 0.5 newton-meter preload from the spring to initially position the mask 90 degrees from the contoured headband and an additional 4.5 newton-meters of loaded force applied by the hinged spring 64 to the mask 16 for the user's face.

13. The system according to claim 8 further comprising an air source which provides from greater than zero to twenty cubic feet per minute positive pressure to the mask.

14. The system according to claim 8 wherein the mask comprises a swivel air intake spout.

15. The system according to claim 8 further comprising a quick couple fastener between the second strap and the mask.

16. The system according to claim 8 wherein the spring applies a load of between 3.0 and 5.5 newton-meters.

17. The system according to claim 8 comprising a means to adjust a load applied by the spring.
